(19) United States
(12) Patent Application Publication
(10) Pub. No.: US 2014/0292004 A1
(43) Pub. Date: Oct. 2, 2014

(54) VEHICLE DOOR HANDLE SYSTEM

(71) Applicant: MAGNA MIRRORS OF AMERICA, INC., Holland, MI (US)

(72) Inventor: James A. Ruse, Allegan, MI (US)

(73) Assignee: MAGNA MIRRORS OF AMERICA, INC., Holland, MI (US)

(21) Appl. No.: 14/230,636

(22) Filed: Mar. 31, 2014

Related U.S. Application Data
(60) Provisional application No. 61/807,048, filed on Apr. 1, 2013.

(51) Int. Cl. E05B 85/10

(52) U.S. Cl. CPC E05B 85/10
USPC 292/336.3

(57) ABSTRACT

A door handle system includes a door handle assembly that is configured to mount at a handle region of a vehicle door and includes a handle portion fixedly disposed at the vehicle door and a strain gauge sensor. The strain gauge sensor is for sensing at least one of (i) grasping of the handle portion by a user and (ii) pulling at the handle portion by a user. Responsive to sensing by the sensor, a signal is communicated that causes a latch of the vehicle door to open to allow the user to open the vehicle door.

### CROSS REFERENCE TO RELATED APPLICATION

The present application claims the filing benefits of U.S. provisional application Ser. No. 61/807,048, filed Apr. 1, 2013, which is hereby incorporated herein by reference in its entirety.

### FIELD OF THE INVENTION

The present invention relates to door handles for vehicles and, more particularly, to an exterior door handle for opening a side door of a vehicle.

### BACKGROUND OF THE INVENTION

A door handle for a vehicle door typically includes a handle portion that is pivotable relative to a base portion, whereby pivotal movement of the handle portion pulls at a cable or rod to electrically trigger or move a latch mechanism to release the latch and open the door.

### SUMMARY OF THE INVENTION

The present invention provides a door handle assembly for a door of a vehicle, where the door handle comprises a static or non-moving door handle. The door handle assembly includes a sensor or the like at the static door handle portion (or the door latch mechanism or device is responsive to a sensor or the like at the vehicle or vehicle door or door handle), whereby the door latch mechanism or device operates to open the vehicle door responsive to a signal indicative of a person's hand grasping at and/or pulling at the static door handle.

According to an aspect of the present invention, a door handle assembly for a door of a vehicle includes a handle portion fixedly mountable at the vehicle door. The door handle assembly includes a sensor a sensor for sensing at least one of (i) grasping of the handle portion by a user and (ii) pulling at the handle portion by a user. Responsive to sensing by the sensor, the door handle assembly is operable to communicate a signal that causes a latch of the vehicle door to open to allow the user to open the vehicle door.

Optionally, the sensor may comprise a strain gauge sensor that is operable to sense a strain at the handle portion when the handle portion is at least one of (i) grasped by a user and (ii) pulled at by a user. Optionally, the sensor may comprise a capacitive sensor or the like for sensing grasping of the handle portion by a user. Optionally, an illumination module may be disposed at the handle portion. Optionally, the latch of the vehicle door may be opened or released responsive to the door handle assembly and responsive to a passive entry system of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a door handle assembly of the present invention;

FIG. 2 is a perspective view of the door handle assembly of FIG. 1;

FIG. 3 is another perspective view of a door handle assembly of the present invention;

FIG. 4 is a perspective view of an inner side of the door handle assembly of FIG. 3, with an inner cover removed to show additional details;

FIG. 5 is another perspective view of the inner side of the door handle assembly similar to FIG. 4, but with the inner cover shown; and

FIG. 6 is a perspective view of the inner cover and strain gauge of the door handle assembly of the present invention.

### DESCRIPTION OF THE PREFERRED EMBODIMENTS

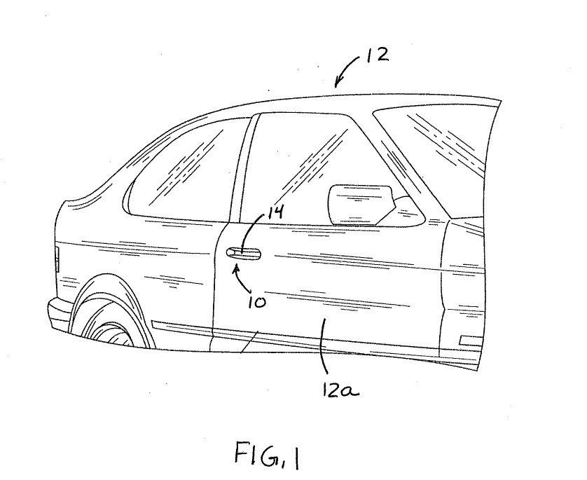

Referring now to the drawings and the illustrative embodiments depicted therein, a vehicle door handle assembly 10 is mountable to a door 12a of a vehicle 12 and operable to release a latch mechanism (not shown) of the door 12a to open the vehicle door (FIG. 1). Vehicle door handle assembly 10 includes a handle portion 14 that is disposed at the door and that is fixedly mounted at the door or to a bracket mounted to the door.

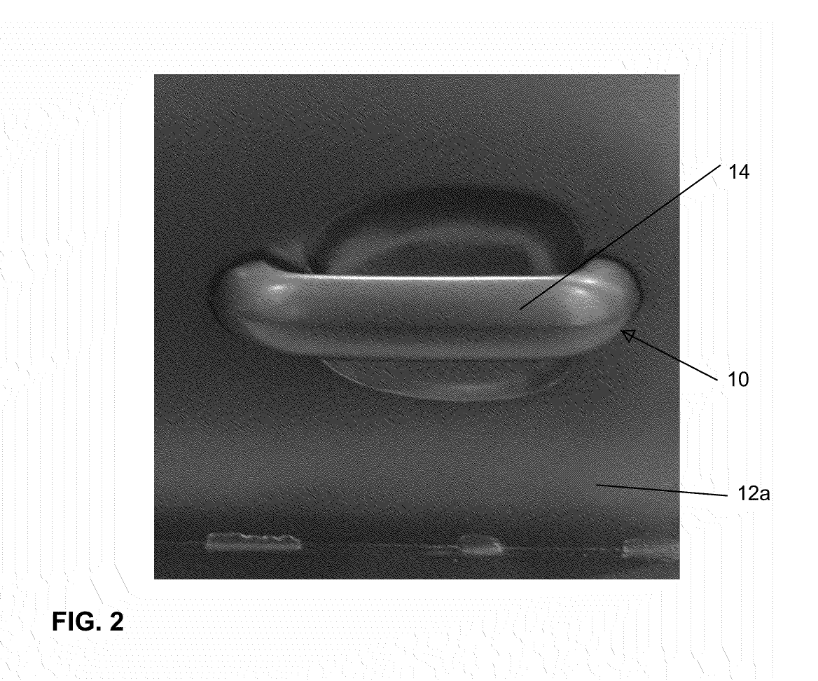

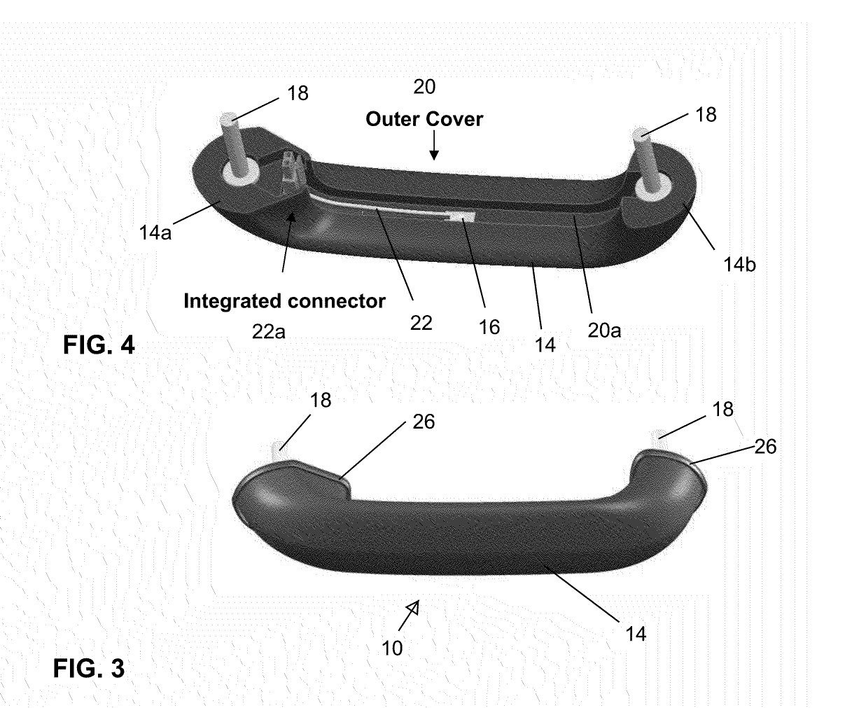

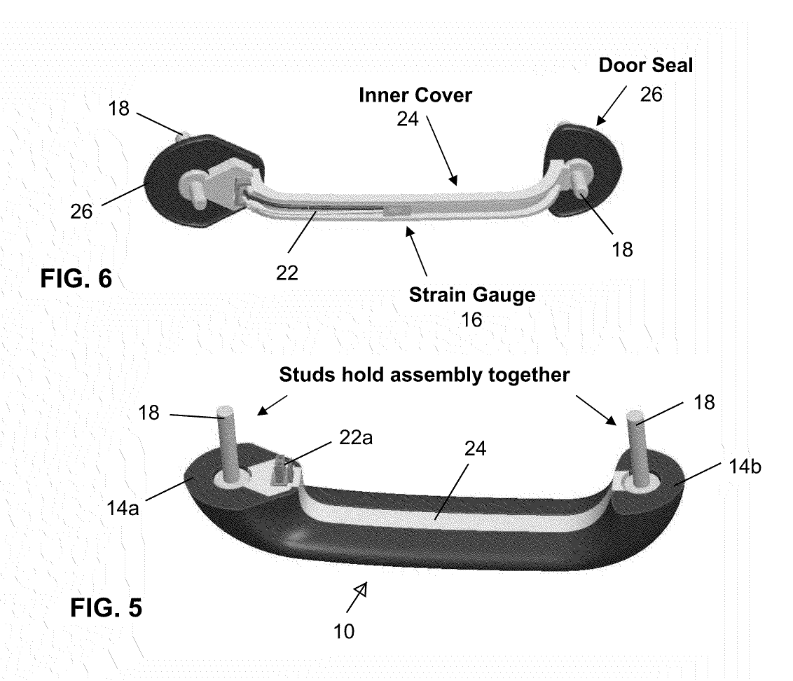

Door handle assembly 10 may comprise any suitable type of door handle assembly, and may include or incorporate aspects of the door handle assemblies described in U.S. Pat. Nos. 6,349,450; 6,550,103; 6,907,643; 7,407,203 and/or 8,333,492, and/or U.S. patent applications, Ser. No. 12/499,183, filed Jul. 8, 2009 (Attorney Docket DON09 P-1538); Ser. No. 12/499,183, filed Oct. 12, 2009 (Attorney Docket DON09 P-1563); Ser. No. 12/976,594, filed Dec. 22, 2010 (Attorney Docket DON09 P-1666); and/or Ser. No. 13/674,458, filed Nov. 12, 2012 (Attorney Docket DON09 P-1837), which are hereby incorporated herein by reference in their entireties. Although shown in FIGS. 1-6 as a strap type handle, the handle assembly may comprise any suitable type of vehicle door handle assembly, such as a paddle type vehicle door handle assembly (having a paddle or the like that may be pulled at to open the vehicle door) or other type of vehicle door handle assembly, while remaining within the spirit and scope of the present invention.

In the illustrated embodiment, handle assembly 10 includes a strap or handle portion 14 that is fixedly disposed relative to the door and includes a strain gauge or sensor 16 (FIGS. 4 and 6) that detects a strain at the door handle portion 14 (such as due to a person grasping the handle portion and pulling at the handle portion when the door is closed). The handle portion 14 comprises a strap type handle with its ends 14a, 14b fixedly attached at the vehicle door 12a, such as via respective mounting posts or studs 18 or the like. The handle portion 14 may comprise a plastic or metallic handle portion and may have a cover portion 20 with a recess or groove or channel 20a formed along a portion thereof (such as along an inner surface of the handle portion as shown in FIG. 4).

In the illustrated embodiment, the strain gauge or sensor 16 is disposed at and received in the channel at least partially along the channel (such as generally at or near a center region of the handle portion as shown in FIG. 4), with an electrical wire or lead 22 extending along the channel and having an electrical connector 22a at an end 14a of the handle portion 14 for electrically conductively connecting to a wire or lead or connector of the vehicle door 12a.

In the illustrated embodiment, an inner cover 24 is disposed over and/or within the channel 20a to cover the sensor 16 and wires 22 and to partially encase or encapsulate or house the connector 22a. The inner cover may have a channel formed at least partially therealong so as to at least partially receive the sensor and wires therein, whereby the inner cover and sensor and wires may be assembled as a unit and attached as a unit to the door handle portion, such as via a snap connection or the like. As shown in FIG. 6, door seals 26 may be provided at the mounting studs 18 to seal the door handle assembly 10 at the vehicle door to limit water intrusion into the vehicle door or into the channel of the door handle portion when the studs are attached at the vehicle door (such as via threaded fasteners attaching or securing the studs to a bracket or mounting element at or in the vehicle door).

The strain gauge sensor 16 of the door handle assembly 10 is operable to detect a pull at the handle by a user and an output is generated by the strain gauge sensor indicative of such a pull, whereby, responsive to the output, an electrically operable door latch or an actuator of the handle assembly or the like is actuated to release the door latch to allow the door to be opened. The static handle assembly 10 thus captures the desire or intent of the user to open the vehicle door by sensing an effort or action by the user (such as by sensing slight strain at the door handle portion when the user grasps the handle portion and begins to pull at the door handle portion to open the vehicle door). The static door handle assembly, responsive to such pulling (and responsive to an initial slight strain at the handle portion, so that the user does not have to exert any significant effort to cause the door latch to open), may communicate a signal to an electronically actuated latch or E-latch of the vehicle door to unlatch the door. The static door handle assembly of the present invention may work with an E-latch of the vehicle door or an actuator at or in the door handle assembly that releases the door latch.

The door handle assembly is thus operable to open the vehicle door when a user grasps the door handle portion at the side of the vehicle door. The door handle assembly may also be operable in conjunction with a passive keyless entry or other sensing system that is operable to determine whether or not the person at the vehicle door is authorized for entry into the vehicle, and may only open the vehicle door when that system recognizes the user or key fob or transmitting device associated with the owner or authorized user of the vehicle. Optionally, the door handle assembly may be associated with or in communication with a door zone module, such as by utilizing aspects of the vehicle door systems described in U.S. patent application Ser. No. 12/499,183, filed Jul. 8, 2009 (Attorney Docket DON09 P-1538), which is hereby incorporated herein by reference in its entirety.

Although shown and described above as comprising a strain gauge or sensor at the handle portion of the door handle assembly, optionally other types of sensors may be provided at the door handle portion, such as at an inner or door-facing surface of the door handle portion. For example, the door handle portion may include a capacitive sensor or the like disposed thereat, which is operable to detect a touch of the user at the door handle portion. The door handle assembly and sensor thereof may be associated with or operate in conjunction with a passive keyless entry system or the like, and may include an antenna, sensor, tactile button (such as for locking the vehicle door) or the like.

Thus, the door handle assembly of the present invention provides a vehicle door handle with no moving parts. The door handle assembly may have any shaped or designed or desired handle portion to fit into current door handle designs. By eliminating moving parts, the door handle assembly of the present invention may have a reduced mass and may achieve reduced costs. Also, the non-moving door handle assembly provides a water tight seal at the door. The door handle assembly of the present invention also provides enhanced assembly processes for both the assembly or manufacture of the door handle and the assembly or manufacture of the vehicle door. The door handle assembly of the present invention may also provide a tamper resistant door handle, while meeting OEM door handle specifications and Federal Safety requirements.

Optionally, the door handle assembly may include a light module or lighting element, such as for illuminating the door handle portion or the inner portion of the door handle portion, so that the user can readily see and discern the door handle when approaching the vehicle in low lighting conditions. The lighting element may comprise a strip light or pocket light or the like, and the door handle assembly may include a ground illumination light and/or other light or lighting element, such as a projection light or the like, such as by utilizing aspects of the door handle assemblies and lighting systems described in U.S. Pat. Nos. 5,371,659; 5,497,305; 5,669,699; 5,823,654; 6,349,450; and/or 6,550,103, and/or U.S. patent applications, Ser. No. 12/499,183, filed Jul. 8, 2009 (Attorney Docket DON09 P-1538); Ser. No. 12/499,183, filed Oct. 12, 2009 (Attorney Docket DON09 P-1563); Ser. No. 12/976,594, filed Dec. 22, 2010 (Attorney Docket DON09 P-1666); and/or Ser. No. 13/674,458, filed Nov. 12, 2012 (Attorney Docket DON09 P-1837), which are hereby incorporated herein by reference in their entireties.

Optionally, the door handle assembly may include or may be associated with an antenna for receiving signals from or communicating with a remote device. For example, the antenna (such as, for example, an antenna of the types described in U.S. Pat. No. 6,977,619, which is hereby incorporated herein by reference in its entirety) may communicate a signal to the door locking system via a wire connection or the like, or wirelessly, such as via a radio frequency signal or via an infrared signal or via other wireless signaling means. Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408; and/or 6,477,464, which are all hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208; and/or 6,568,839, all of which are hereby incorporated herein by reference in their entireties), or the vehicle ignition, or any other desired system, while remaining within the spirit and scope of the present invention. The door handle and/or illumination module may be in communication with other systems and/or controls of the vehicle door and/or vehicle, such as by utilizing aspects of the door systems described in U.S. patent application Ser. No. 12/499,183, filed Jul. 8, 2009 (Attorney Docket DON09 P-1538), which is hereby incorporated herein by reference in its entirety.

Optionally, the door handle assembly of the present invention may include a soft touch handle portion, such as utilizing the principles described in U.S. Pat. Nos. 6,349,450; 6,550,103; and 6,907,643, which are hereby incorporated herein by reference in their entireties. Optionally, the door handle assembly may include an antenna or the like, such as for sensing or transmitting signals, such as described in U.S. Pat. No. 6,977,619, which is hereby incorporated herein by reference in its entirety.

Changes and modifications to the specifically described embodiments may be carried out without departing from the principles of the present invention, which is intended to be limited only by the scope of the appended claims as interpreted according to the principles of patent law.

1. A door handle system for a door of a vehicle, said door handle system comprising:
a door handle assembly configured to fixedly mount at a handle region of a vehicle door;
wherein said door handle assembly comprises a handle portion;
wherein said door handle assembly comprises a strain gauge sensor disposed at said handle portion;
wherein said strain gauge sensor senses at least one of (i) grasping of said handle portion by a user and (ii) pulling at said handle portion by a user;
wherein said strain gauge sensor senses a strain at said handle portion when said handle portion is at least one of (i) grasped by a user and (ii) pulled at by a user; and
wherein, responsive to sensing by said strain gauge sensor, a signal is communicated that causes a latch of the vehicle door to open to allow the user to open the vehicle door.

2. The door handle system of claim 1, wherein an illumination module is disposed at said handle portion.

3. The door handle system of claim 2, wherein said illumination source is actuatable responsive to a passive entry system of the vehicle.

4. The door handle system of claim 1, wherein the latch of the vehicle door opens responsive to said door handle system and responsive to a passive entry system of the vehicle.

5. The door handle system of claim 1, wherein said signal is communicated to a control of said door handle system, and wherein said control controls the latch of the vehicle door.

6. The door handle system of claim 1, wherein said strain gauge sensor is disposed along an inner portion of said handle portion.

7. The door handle system of claim 6, wherein said strain gauge sensor is disposed along a channel established at least partially along said inner portion of said handle portion.

8. The door handle system of claim 1, wherein said handle portion is configured to have a grasping portion that is spaced from a door panel at the handle region of the vehicle door via handle attaching portions at opposite ends of said grasping portion, and wherein said strain gauge sensor is disposed at said grasping portion.

9. The door handle system of claim 8, wherein said strain gauge sensor is disposed at an inner portion of said handle portion that generally faces the vehicle door panel when said door handle assembly is mounted at the handle region of the vehicle door.

10. The door handle system of claim 9, wherein said strain gauge sensor is disposed along a channel established at least partially along said inner portion of said handle portion.

11. The door handle system of claim 1, wherein said strain gauge sensor is electrically connected to electrical wiring of the vehicle door via an electrical connector disposed at one of a handle attaching portion of said door handle assembly.

12. A door handle system for a door of a vehicle, said door handle system comprising:
a door handle assembly configured to fixedly mount at a handle region of a vehicle door;
wherein said door handle assembly comprises a handle portion;
wherein said door handle assembly comprises a strain gauge sensor disposed at said handle portion;
wherein said strain gauge sensor is disposed along a channel established at least partially along an inner portion of said handle portion;
wherein said strain gauge sensor senses at least one of (i) grasping of said handle portion by a user and (ii) pulling at said handle portion by a user;
wherein said strain gauge sensor senses a strain at said handle portion when said handle portion is at least one of (i) grasped by a user and (ii) pulled at by a user; and
wherein, responsive to sensing by said strain gauge sensor, a signal is communicated that causes a latch of the vehicle door to open to allow the user to open the vehicle door; and
wherein said signal is communicated to a control of said door handle system, and wherein said control controls the latch of the vehicle door.

13. The door handle system of claim 12, wherein an illumination module is disposed at said handle portion.

14. The door handle system of claim 13, wherein said illumination source is actuatable responsive to a passive entry system of the vehicle.

15. The door handle system of claim 12, wherein the latch of the vehicle door opens responsive to said door handle system and responsive to a passive entry system of the vehicle.

16. The door handle system of claim 12, wherein said strain gauge sensor is electrically connected to electrical wiring of the vehicle door via an electrical connector disposed at a handle attaching portion of said door handle assembly.

17. A door handle system for a door of a vehicle, said door handle system comprising:
a door handle assembly configured to fixedly mount at a handle region of a vehicle door;
wherein said door handle assembly comprises a handle portion;
wherein said handle portion is configured to have a grasping portion that is spaced from a door panel at the handle region of the vehicle door via handle attaching portions at opposite ends of said grasping portion;
wherein said door handle assembly comprises a strain gauge sensor disposed at said grasping portion of said handle portion;
wherein said strain gauge sensor is electrically connected to electrical wiring of the vehicle door via an electrical connector disposed at one of said handle attaching portions of said door handle assembly;
wherein said strain gauge sensor senses at least one of (i) grasping of said handle portion by a user and (ii) pulling at said handle portion by a user;
wherein said strain gauge sensor senses a strain at said handle portion when said handle portion is at least one of (i) grasped by a user and (ii) pulled at by a user; and
wherein, responsive to sensing by said strain gauge sensor, a signal is communicated that causes a latch of the vehicle door to open to allow the user to open the vehicle door.

18. The door handle system of claim 17, wherein an illumination module is disposed at said handle portion, wherein said illumination source is actuatable responsive to a passive entry system of the vehicle.

19. The door handle system of claim 17, wherein said signal is communicated to a control of said door handle system, and wherein said control controls the latch of the vehicle door.

20. The door handle system of claim 17, wherein said strain gauge sensor is disposed at an inner portion of said handle portion that generally faces the vehicle door panel when said door handle assembly is mounted at the handle region of the vehicle door, and wherein said strain gauge sensor is disposed along a channel established at least partially along said inner portion of said handle portion.
